(19) United States
(12) Patent Application Publication
(10) Pub. No.: US 2014/0191063 A1
(43) Pub. Date: Jul. 10, 2014

(54) AROMATIC NEBULIZING DIFFUSER

(71) Applicant: SERENE HOUSE INTERNATIONAL ENTERPRISE LTD., Road Town (VG)

(72) Inventor: Ming Jen Hsiao, Miaoli County (TW)

(73) Assignee: SERENE HOUSE INTERNATIONAL ENTERPRISE LTD., Road Town (VG)

(21) Appl. No.: 13/736,772

(22) Filed: Jan. 8, 2013

(51) Int. Cl. B05B 17/06

(52) U.S. Cl. CPC B05B 17/0607
USPC 239/102.2

(57) ABSTRACT

An aromatic nebulizing diffuser includes a housing, a fluid container movable fluid container in and out of a top opening of the housing and providing a nozzle hole for spraying a mist of aromatic fluid droplets, an elastic lift unit for lifting the fluid container out of the housing, a control unit, and a power switch actuator movable with the fluid container to switch on/off the control unit, causing the control unit to eject a mist of aromatic fluid droplets out of the fluid container when the fluid container is lifted out of the top opening of the housing, or to stop the operation when the fluid container is received inside the housing.

### BACKGROUND OF THE INVENTION

1. Field of the Invention

The present invention relates to an aromatic nebulizing diffuser and more particularly, to such an aromatic nebulizing diffuser, which has the advantages of ease of operation, nozzle hole contamination prevention, compact size, and high applicability in office, small personal space or any other different situations.

2. Description of the Related Art

With fast economic development and technological advancement and the rise of human civilization, there is a growing emphasis on the level of material and spiritual life, and having a good living environment has become the goal of people actively want to pursue. Further, air conditioners, air purifiers, fragrances, electric jasmines, aromatic nebulizing diffusers, perfume dispensers are intensively used in offices, rooms, cars, and many other living environments to eliminate bad smells and stale air, improving the work efficiency and mental health. Further, many new designs of aromatic nebulizing diffusers and perfume dispensers have been continuously created and have appeared on the market.

However, commercial aromatic nebulizing diffusers and perfume dispensers commonly have a large size and a complicated structure. Further, these aromatic nebulizing diffusers and perfume dispensers are not easy to operate. Further, the outer appearances of these aromatic nebulizing diffusers and perfume dispensers are not attractive, lowering consumers willing to buy these products. Further, these aromatic nebulizing diffusers and perfume dispensers are commonly designed for use in a large indoor space, not practical for use in a small personal working space or tabletop space.

Further, commercial aromatic nebulizing diffusers and perfume dispensers are not retractable to reduce the size when not in use.

Further, when commercial aromatic nebulizing diffusers and perfume dispensers are not in use, the nozzle hole is kept exposed to the outside open air and can be contaminated by surrounding dust easily, lowering the level of hygiene.

Therefore, it is desirable to provide an aromatic nebulizing diffuser, which is practical for use in a large space as well as a small space and, which maintains a high level of hygiene when not in use.

### SUMMARY OF THE INVENTION

The present invention has been accomplished under the circumstances in view. It is main object of the present invention to provide an aromatic nebulizing diffuser, which has the advantages of ease of operation, compact size, and high applicability in office, small personal space or any other different situations.

It is another object of the present invention to provide an aromatic nebulizing diffuser, which effectively protects the nozzle hole against contamination.

To achieve these and other objects of the present invention, an aromatic nebulizing diffuser comprises a housing, a fluid container, an elastic lift unit, a power switch actuator, and a control unit. The housing defines therein accommodation chamber having a top opening. The fluid container is adapted to hold an aromatic fluid, having an oscillator mounted therein corresponding to a nozzle hole at one upright peripheral wall thereof. The fluid container is mounted in the housing and movable in and out of a top opening of the housing. When the fluid container is lifted, the nozzle hole is exposed to the outside of the housing for enabling a mist of aromatic fluid droplets to be ejected out of the housing. When the fluid container is lowered to the inside of the housing, the nozzle hole is kept from sight. The elastic lift unit is mounted inside the housing and adapted to lift the fluid container out of the top opening of the housing. When the fluid container is lowered and received inside the housing, the elastic lift unit holds the fluid container in the received position. The power switch actuator is mounted at the fluid container and movable with the fluid container. The control unit is mounted inside the housing, comprising an oscillator control circuit board electrically connected with the oscillator, a power switch sensing circuit board adapted to switch on/off a power loop subject to the control of the power switch actuator. When the fluid container is lifted and extended out of the top opening of the housing, the power switch sensing circuit board switches on the power loop. On the contrary, when the fluid container is lowered and received inside the housing, the power switch sensing circuit board switches off the power loop. Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an elevational view of an aromatic nebulizing diffuser in accordance with the present invention.

FIG. 2 is an exploded view of an upper part of the aromatic nebulizing diffuser in accordance with the present invention.

FIG. 3 is an exploded view of the fluid container of the aromatic nebulizing diffuser in accordance with the present invention.

FIG. 4 is a sectional front elevation of the aromatic nebulizing diffuser in accordance with the present invention.

FIG. 5 is a schematic sectional view of the present invention, illustrating the fluid container lifted out of the housing.

FIG. 6 corresponds to FIG. 5, illustrating the fluid container received inside the housing.

### DETAILED DESCRIPTION OF THE PREFERRED EMBODIMENT

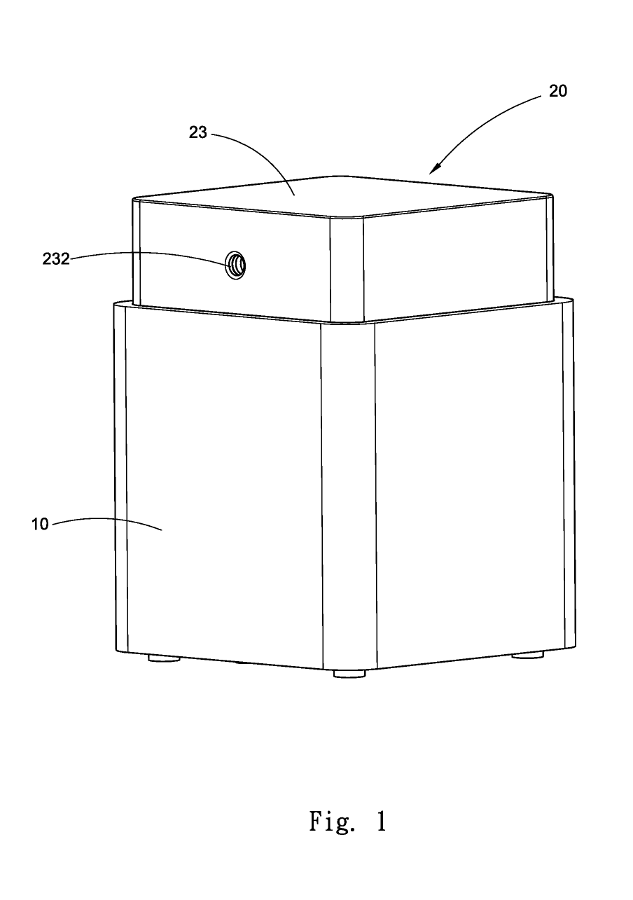

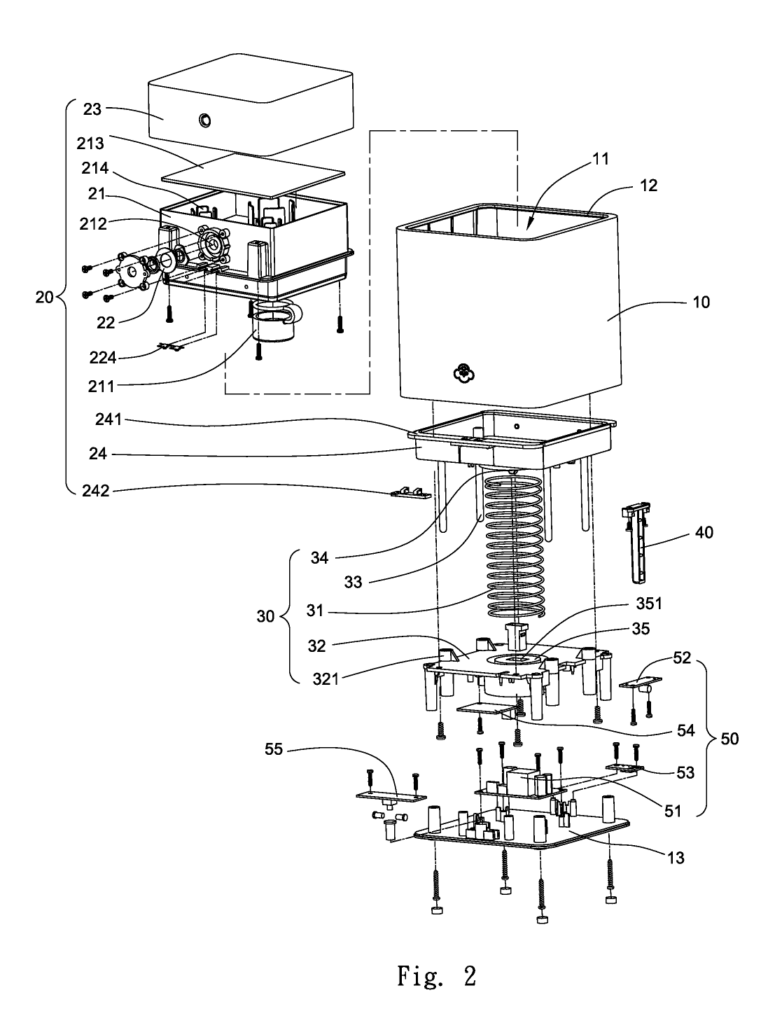

Referring to FIGS. 1 and 2, an aromatic nebulizing diffuser in accordance with the present invention is shown. The aromatic nebulizing diffuser comprises a housing 10 defining therein an accommodation chamber having a top opening 11, a fluid container 20 mounted in the accommodation chamber of the housing 10 to hold an aromatic fluid and movable in and out of the top opening 11, an oscillator 22 mounted in the fluid container 20 and operable to oscillate the contained aromatic fluid into a mist of aromatic droplets that goes out of at least one nozzle hole 212 of the fluid container 20 when fluid container 20 is extended out of the top opening 11 of the housing 10, an elastic lift unit 30 mounted inside the housing 10 and capable of pushing the fluid container 20 out of the top opening 11 by means of an elastic member 31 and controllable to hold the fluid container 20 in position after the fluid container 20 having been pushed into the inside of the top opening 11, and a control unit 50 mounted in the housing 10 and comprising an oscillator control circuit board 51 electrically connected with the oscillator 22.

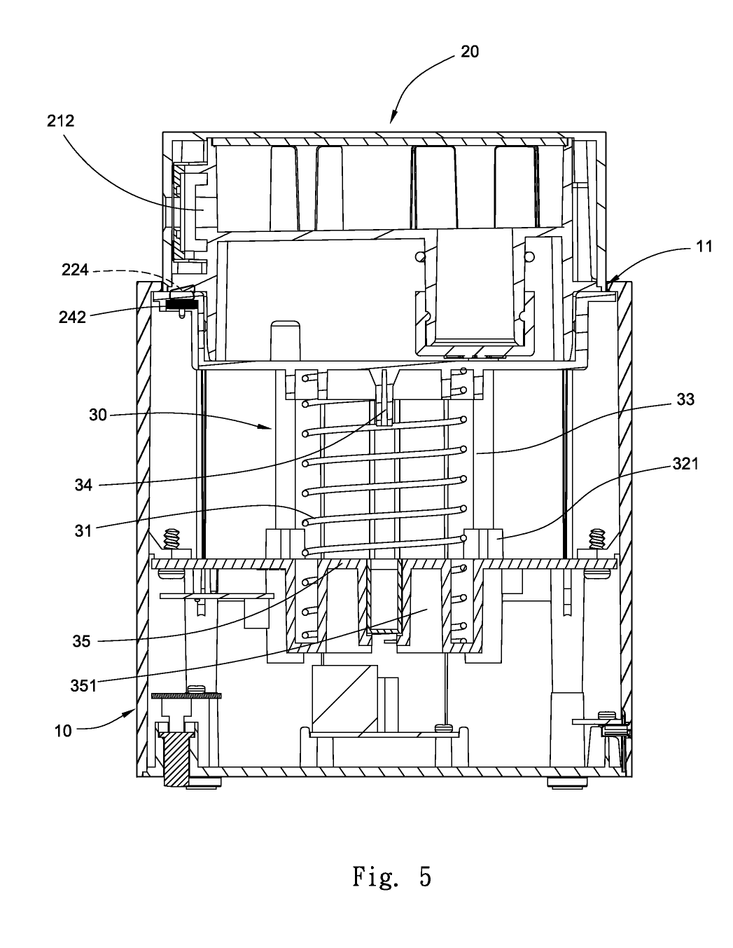

Thus, the fluid container 20 can be lifted from the housing 10 during application. At this time, the control unit 50 provides electricity to the oscillator control circuit board 51 and the oscillator 22, causing the oscillator 22 to oscillate the contained aromatic fluid into a mist of aromatic fluid droplets, enabling the mist of aromatic fluid droplets to fly out of at least one nozzle hole 212 of the fluid container 20. When not in use, the fluid container 20 can be forced down and received inside the housing 10. For the advantages of ease of operation, compact size, convenience in use and free usability, this design of aromatic nebulizing diffuser is suitable for use in office, small personal space, and any of a variety places (see FIGS. 1, 5 and 6).

Referring to FIG. 2 again, the housing 10 can be made out of aluminum alloy and coated with a layer of plastic covering, having a rim 12 extending around the top opening 11 and a bottom cover 13 covered the bottom side of the accommodation chamber.

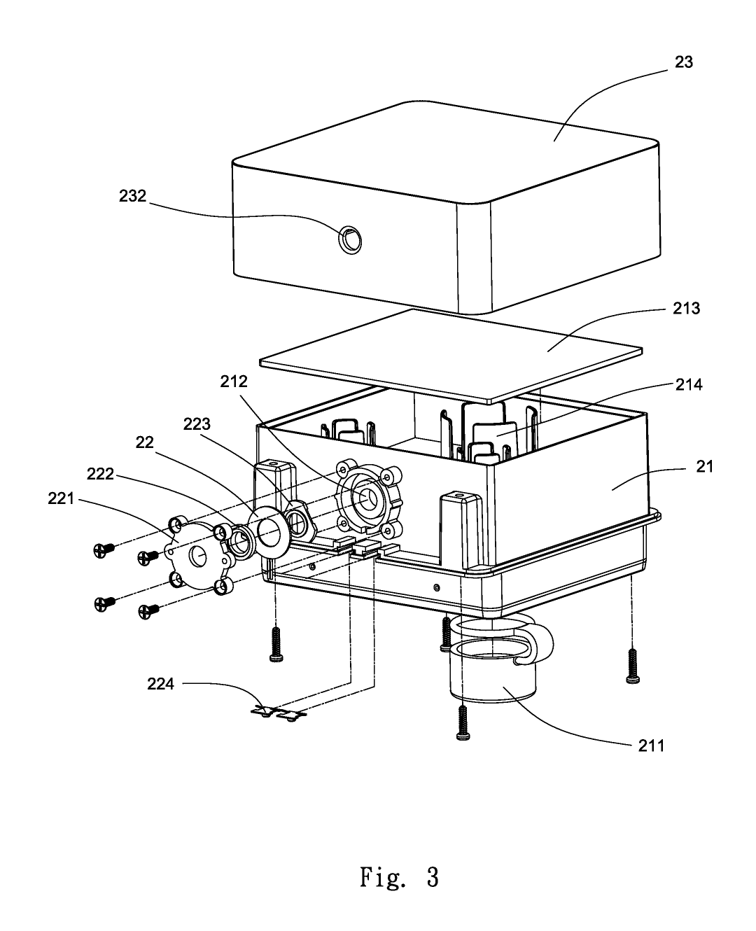

Referring to FIGS. 3 and 4 and FIGS. 1 and 2 again, the fluid container 20 comprises a lower container body 21, an upper container body 23, and a connection frame 24. The lower container body 21 is adapted for holding an aromatic fluid, comprising a plug 211 detachably mounted in a bottom side thereof. After opening of the plug 211 from the lower container body 21, the user can fill an aromatic fluid into the lower container body 21. Further, the aforesaid nozzle hole 212 is located on an upright peripheral wall of the lower container body 21. Further, the aforesaid oscillator 22 is a piezoelectric ceramic resonator oscillator mounted in the lower container body 21 corresponding to the nozzle hole 212 for oscillating the aromatic fluid to produce a mist of aromatic fluid droplets, enabling the produced mist of aromatic fluid droplets to fly out of the nozzle hole 212 of the lower container body 21 of the fluid container 20. Further, the oscillator 22 is secured to the lower container body 21 corresponding to the nozzle hole 212 by a screw cap 221. Further, water seal rings 222;223 are secured to the lower container body 21 at opposing front and back sides of the oscillator 22 by the screw cap 221 to prevent leakage.

The upper container body 23 is capped on the lower container body 21 at the top, comprising a hole 232 in communication with the nozzle hole 212. The connection frame 24 is sleeved onto the lower container body 21 at the bottom side. The fluid container 20 is inserted into the top opening 11 of the housing 10 and movable up and down relative to the housing 10. The connection frame 24 comprises a protrusion 241 corresponding to the top flange 12 of the housing 10. When the fluid container 20 is lifted out of the housing 10, the protrusion 241 is stopped at the top flange 12 to keep the fluid container 20 from falling out of the housing 10. Further, when the fluid container 20 is extended out of the housing 10, the nozzle hole 212 and the hole 232 are exposed outside the housing 10. On the contrary, when the fluid container 20 is lowered and received inside the housing 10, the nozzle hole 212 and the hole 232 are kept inside the housing 10.

The lower container body 21 has its top side sealed by a top cover plate 213, comprising a plurality of upright support bars 214 of smoothly arched cross section upwardly extended from the bottom wall thereof. When a negative pressure is produced in the lower container body 21 to suck down the top cover plate 213 after a certain amount of the contained aromatic fluid has been ejected during operation of the aromatic nebulizing diffuser, the upright support bar 214 support the top cover plate 213, preventing deformation of the top cover plate 213.

Further, the aforesaid oscillator 22 has a plurality of metal spring leaves 224 connected to the bottom side thereof. The connection frame 24 further comprises a metal contact plate 242 mounted at the protrusion 241. When the spring leaves 224 and the metal contact plate 242 are electrically conducted, the control unit 50 provides electricity to the oscillator 22 and controls the oscillator 22 to oscillate, causing the fluid container 20 to eject a mist of aromatic fluid droplets.

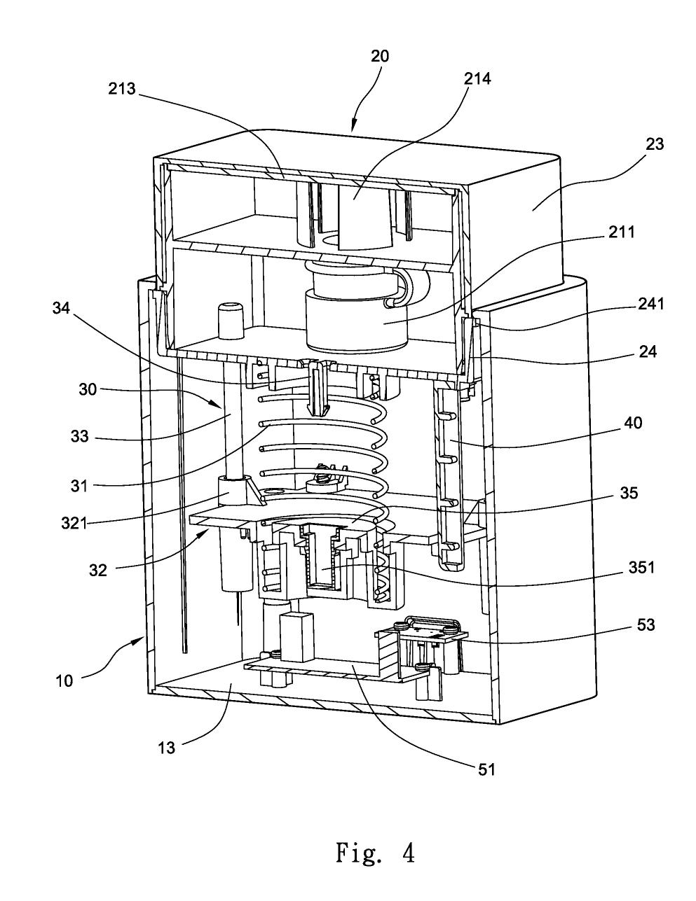

Referring to FIGS. 2 and 4 again, the elastic lift unit 30 is mounted inside the housing 10, comprising an elastic member 31, a guide base 32, and a plurality of guide rods 33. The elastic member 31 has its top end stopped at the bottom side of the connection frame 24 and its bottom side stopped at the top side of the guide base 32. Thus, the elastic member 31 imparts an upward pressure to the fluid container 20 to lift the fluid container 20 out of the housing 10. The guide base 32 comprises a plurality of guide tube 321. The guide rods 33 are mounted at the bottom side of the connection frame 24 and respectively inserted through the guide tubes 321 to guide vertical movement of the fluid container 20 relative to the housing 10 steadily.

Further, the elastic lift unit 30 comprises a T-shaped male buckle member 34 downwardly extended from the bottom side of the connection frame 24, and a female buckle member 35 located at the center of the guide base 32 and defining therein a buckle hole 351 for operative engagement with the T-shaped male buckle member 34. Thus, when the fluid container 20 is lowered into the inside of the housing 10, the T-shaped male buckle member 34 and the female buckle member 35 are engaged together, holding the fluid container 20 positively in the housing 10. When pressed the fluid container 20 to force down the T-shaped male buckle member 34 in the buckle hole 351 again, the T-shaped male buckle member 34 will be released front the constraint of the female buckle member 35, enabling the fluid container 20 to be lifted to the outside of the housing 10.

Referring to FIG. 6 and FIGS. 2 and 4 again, the aromatic nebulizing diffuser of the present invention further comprises a power switch actuator 40 mounted at one side of the fluid container 20 and movable with the fluid container 20. The control unit 50 further comprises a function control circuit board 54, a power switch sensing circuit board 52, and a power source 53. The control unit 50 is mounted inside the housing 10 at a predetermined location below the guide base 32.

The function control circuit board 54 is disposed at the bottom side of the guide base 32 and electrically connected to the oscillator control circuit board 51, the power switch sensing circuit board 52 and the power source 53 to form a power loop. The function control circuit board 54 comprises a programmable control circuit for enabling the user to set different aroma diffusing modes subject to different application environments or requirements.

The power switch sensing circuit board 52 is mounted at the bottom side of the guide base 32 at a predetermined location. The power switch actuator 40 is movable with the fluid container 20 to touch the power switch sensing circuit board 52 when the fluid container 20 is lowered into the inside of the housing 10, thereby cutting off the power loop. When the fluid container 20 is lifted out of the housing 10, the power switch actuator 40 is moved away from the power switch sensing circuit board 52, causing the power switch sensing circuit board 52 to close the power loop.

The function control circuit board 54 is electrically connected to the oscillator control circuit board 51, the power switch sensing circuit board 52 and the power source 53. Therefore, the power source 53 can provide electricity to the function control circuit board 54. When the power switch actuator 40 is lowered to touch the power switch sensing circuit board 52 to cut off the power loop, the function control circuit board 54 is off. When the power switch actuator 40 is lifted with the fluid container 20 away from the power switch sensing circuit board 52, the power switch sensing circuit board 52 gives a signal to the function control circuit board 54 to receive electricity from the power source 53, enabling electricity to be transmitted to the oscillator control circuit board 51 to drive the oscillator 22.

The oscillator control circuit board 51 is mounted at the bottom cover 13 and electrically connected to the metal contact plate 242 for driving the oscillator 22, causing a mist of aromatic fluid droplets to be diffused out of the fluid container 20.

The power source 53 can be a USB power source mounted inside the housing 10 at a predetermined location. Further, the housing 10 is so configured that the power source 53 is electrically connectable to the power source of an external electronic device, for example, computer, to obtain the necessary working voltage for the aromatic nebulizing diffuser. Thus, the aromatic nebulizing diffuser can be freely used in any place.

The control unit 50 further comprises a selector switch 55 electrically connected to the function control circuit board 54 for enabling the user to select different operation modes.

Further, indicator lights of different colors (not shown), for example, yellow LED and blue LED are provided and controllable by the selector switch 55 to give off a respective different color of light that indicates one respective operation mode.

Referring to FIG. 5 and FIGS. 1 and 2 again, the upper container body 23 of the fluid container 20 is shown extended out of the top opening 11 of the housing 10. During operation of the aromatic nebulizing diffuser, i.e., when going to move the fluid container 20 out of the top opening 11 of the housing 1, press down the fluid container 20 to disengage the T-shaped male buckle member 34 from the female buckle member 35. After disengagement of the T-shaped male buckle member 34 at the bottom side of the connection frame 24 from the female buckle member 35, the elastic member 31 of the elastic lift unit 30 immediately pushes the fluid container 20 upward. Subject to the guiding effect of the guide tubes 321 and the guide rods 33, the fluid container 20 is moved out of the top opening 11 of the housing 1 stably, carrying the power switch actuator 40 away from the power switch sensing circuit board 52 to switch on the power loop, and thus, a mist of aromatic fluid droplets is forced out of the nozzle hole 212 of the fluid container 20 outside the housing 10.

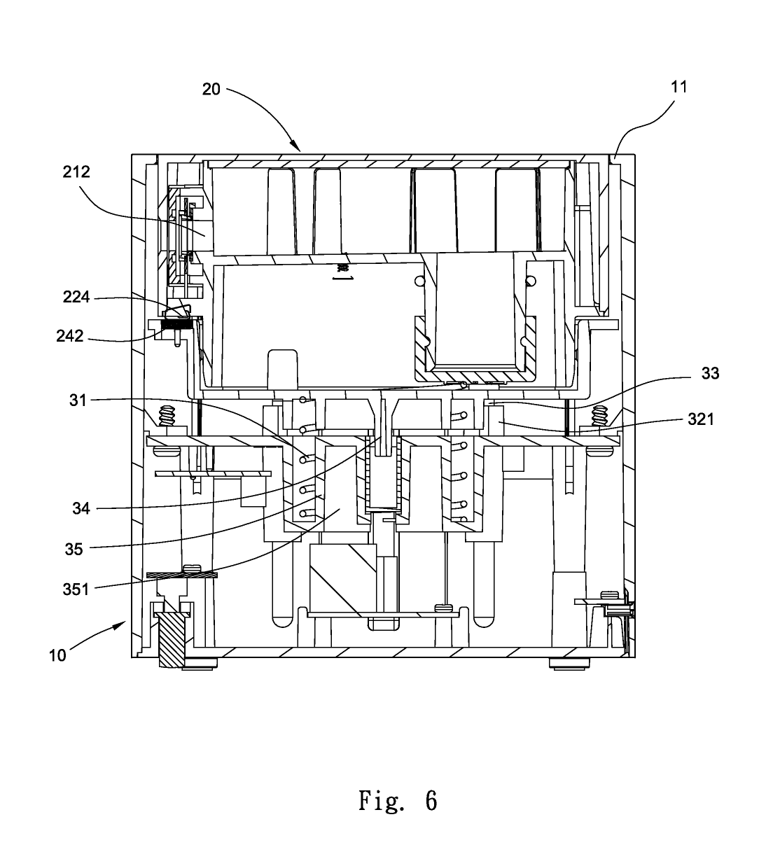

Referring to FIGS. 2 and 6 again, the upper container body 23 of the fluid container 20 is illustrated received in the housing 10 below the top opening 11. When the aromatic nebulizing diffuser is not in use, the user can push the fluid container 20 back into the inside of the housing 10. At this time, the elastic member 31 is compressed to preserve elastic energy, the power switch actuator 40 is lowered to touch the power switch sensing circuit board 52, cutting of the power loop, and the T-shaped male buckle member 34 is forced into operative engagement with the female buckle member 35 to lock the fluid container 20 in the received position. Therefore, the aromatic nebulizing diffuser has the advantages of ease of operation, nozzle hole contamination prevention, compact size, and high applicability in office, small personal space or any other different situations.

When the fluid container 20 is received inside the housing 10, the nozzle hole 212 and the hole 232 are also kept inside housing 10, preventing contamination of the nozzle hole 212 and hole 232 by outside dust.

When going to use the aromatic nebulizing diffuser again, press down the fluid container 20 to disengage the T-shaped male buckle member 34 from the female buckle member 35, enabling the fluid container 20 to be lifted out of the housing 10 by the elastic member 31.

Referring to FIGS. 1 and 2 again, the function control circuit board 54 provides two operation modes for causing the fluid container 20 to eject a mist of aromatic fluid droplets subject one of the following two manners:
1. Large space operation mode: Power on→Rest 2 seconds→ejection 60 seconds→Rest 120 seconds→Ejection 3 seconds→Power off. The actions underlined are repeated.
2. Personal operation mode: Power on→Rest 2 seconds→Ejection 2 seconds→Rest 120 seconds→Power off. The actions underlined are repeated.

In conclusion, the aromatic nebulizing diffuser of the present invention enables the fluid container to be lifted out of the housing to eject a mist of aromatic fluid droplets during operation, or pressed down and received inside the housing when not in use, having the advantages of ease of operation, nozzle hole contamination prevention, compact size, and high applicability in office, small personal space or any other different situations.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An aromatic nebulizing diffuser, comprising:
a housing defining an accommodation chamber having a top opening;
a fluid container mounted in said housing and holding therein an aromatic fluid and movable relative to said housing in and out of said opening of said housing, said fluid container comprising a nozzle hole, and an oscillator adapted for oscillating said aromatic fluid to produce a mist of aromatic fluid droplets and to force the produced mist of aromatic fluid droplets out of said nozzle hole when said fluid container is moved out of said top opening of said housing;
an elastic lift unit mounted in said housing and adapted to lift said fluid container out of said top opening of said housing and capable of holding said fluid container in position when said fluid container is lowered into the inside of said housing; and
a control unit mounted in said housing, said control unit comprising an oscillator control circuit board electrically connected with said oscillator and adapted to drive said oscillator to oscillate when said fluid container is lifted out of said top opening of said housing.

2. The aromatic nebulizing diffuser as claimed in claim 1, wherein said housing comprises a top flange extending around said top opening; said fluid container comprises a lower container body and a connection frame, said lower container body comprising a plug located at a bottom side thereof and openable for refilling of said aromatic fluid into said fluid container, said lower container body carrying said nozzle hole at one upright peripheral wall thereof, said connection frame being sleeved onto said lower container body at a bottom side, said connection frame comprising a protrusion corresponding to said top flange of said housing and stoppable against said top flange of said housing to limit upward movement of said fluid container relative to said housing.

3. The aromatic nebulizing diffuser as claimed in claim 2, wherein said oscillator comprises a plurality of metal spring leaves arranged at a bottom side thereof and electrically connected to said oscillator control circuit board; said fluid container comprises a metal contact plate electrically connected to said oscillator control circuit board and adapted for contacting said metal spring leaves to conduct said oscillator.

4. The aromatic nebulizing diffuser as claimed in claim 2, wherein said lower container body comprises a top cover plate sealing a top side thereof, and a plurality of upright support bars upwardly extended from a bottom wall thereof and stopped against said top cover plate.

5. The aromatic nebulizing diffuser as claimed in claim 2, wherein said fluid container further comprises an upper container body capped on a top side of said lower container body, said upper container body defining a hole in communication with said nozzle hole.

6. The aromatic nebulizing diffuser as claimed in claim 2, wherein said elastic lift unit further comprises a plurality of guide rods mounted at a bottom side of said connection frame, and a guide base spaced blow said connection frame, said guide base comprising a plurality of upright guide tubes respectively coupled to said guide rods to guide movement of said guide rods and said connection frame, and an elastic member stopped between said connection frame and said guide base.

7. The aromatic nebulizing diffuser as claimed in claim 6, wherein said elastic lift unit further comprises a T-shaped male buckle member mounted at a bottom side of said fluid container, and a female buckle member located at said guide base, said female buckle member defining therein a buckle hole for receiving said T-shaped male buckle member to hold said fluid in position when said fluid container is lowered and received inside said housing.

8. The aromatic nebulizing diffuser as claimed in claim 1, further comprising a power switch actuator mounted at one side of said fluid container and movable with said fluid container, wherein said control unit further comprises a function control circuit board, a power switch sensing circuit board and a power source, said function control circuit board being electrically connected to said oscillator control circuit board, said power switch sensing circuit board and said power source for receiving electricity from said power source, said power switch sensing circuit board being forced by said power switch actuator to switch off said function control circuit board when said fluid container is received in said housing, said power switch sensing circuit board being electrically conducted to said function control circuit board to receive electricity from said power source and to drive said oscillator when said fluid container is lifted out of said top opening of said housing to move said power switch actuator away from said function control circuit board.

9. The aromatic nebulizing diffuser as claimed in claim 1, wherein said control unit further comprises a selector switch electrically connected to said function control circuit board for switching said function control circuit board between different operation modes.

10. The aromatic nebulizing diffuser as claimed in claim 1, wherein said power source is a USB power source electrically connectable to an external power supply.
